(19) United States
(12) Patent Application Publication
(10) Pub. No.: US 2008/0123635 A1
(43) Pub. Date: May 29, 2008

(54) MATRIX SWITCHING SYSTEM

(76) Inventors: KEITH Y. Mortensen, New Milford, CT (US); Christopher E. Miller, Kent, CT (US); John Pavlick, New Milford, CT (US); William Eppler, Norwalk, CT (US)

Correspondence Address: MCCORMICK, PAULDING & HUBER LLP, CITY PLACE II, 185 ASYLUM STREET, HARTFORD, CT, 06103, US

(21) Appl. No.: 11/422,347

(22) Filed: Jun. 6, 2006

(51) Int. Cl. H04Q 11/00

(52) U.S. Cl. 370/360

(57) ABSTRACT

An expandable matrix switching system for use in routing video and other signals transmitted over twisted pair cables from a variable number of inputs to a variable number of outputs, the matrix switching system including at least one switch frame having a plurality of input ports for receiving input signals and a plurality of output ports. Each switch frame including a processor for selectively coupling the input ports to one or more of the output ports in response to routing commands from a controller. Each switch frame also including a plurality of cascade output ports coupled to the input ports for cascading input signals to the corresponding input ports of another switch frame in the system. A plurality of the switch frames are connectable one to another providing a scalable matrix switch having a variable number of input ports and output ports controllable as a unitary matrix switch.

### FIELD OF THE INVENTION

The present invention relates generally to switches, and more particularly, to an expandable matrix switching system for routing video and other signals transmitted over twisted pair cables.

### BACKGROUND OF THE INVENTION

The recently developed MultiView Series™ products from Magenta Research of New Milford, Conn. (“Magenta”) have revolutionized the serial transmission of high resolution video and auxiliary signals over Cat5 and other twisted pair cables for distances up to 1500 feet. Magenta's MultiView Series™ products provide a full line of signal transmission products including transmitters, receivers, distribution amplifiers and matrix switches. The MultiView Series™ products have eliminated the need for coaxial cable for the transmission of high quality video signals for distances up to 1500 feet as set forth in co-pending U.S. patent application Ser. No. 10/791,636, which is incorporated herein in its entirety.

Currently, video transmission products such as those identified above, are used in various applications wherein multiple video displays are located some distance from the source of the information being displayed. Courtrooms, transportation terminals, schools, sports arenas and casinos are a few examples where numerous video displays are often used to display information from a source that is located separately from the display devices.

Matrix switches have a plurality of inputs and a plurality of outputs wherein any one output can be selectively connected to any one input. Typically, matrix switches are used in video and other systems for routing signals to numerous output devices from numerous input devices and are controlled either manually or via a computer. For example, the MultiView Series™ products include the MultiView™ Matrix 8×8, and MultiView™ Matrix 16×16 matrix switches which provide non-blocked switching of any signals carried over Cat5 cable including video, audio and auxiliary signals.

A major disadvantage of most prior art matrix switches, including those mentioned above, is that they include internal unscalable backplanes which fix the number of inputs and outputs of the matrix switch. Thus, even with the advantages of the MultiView Series™ products in the transmission of high quality video, audio and auxiliary signals over twisted pair cable, the size and/or flexibility of many video systems is limited by the size of a matrix switch employed therein.

Based on the foregoing, it is the general object of the present invention to provide an expandable matrix switching system for routing video and other signals transmitted over twisted pair cables that improves upon, or overcomes the problems and drawbacks of the prior art.

### SUMMARY OF THE INVENTION

The present invention provides an expandable matrix switching system for use in routing video and other signals transmitted over twisted pair cables from a variable number of inputs to a variable number of outputs. The matrix switching system including one or more modular switch frames having a plurality of input ports for receiving input signals from various input devices and plurality of output ports connectable to one or more destination devices.

Each switch frame includes a processor for selectively coupling the output ports and input ports thereof via a crosspoint matrix switch for routing input signals to selected destination devices in accordance with commands from a controller. Input and output communication ports are also provided on each switch frame for coupling the switch frame to a controller or to another switch frame in the system.

Each switch frame further includes a plurality of cascade output ports, one each coupled to the input ports for cascading input signals to the corresponding input ports of another switch frame in the matrix switching system.

The present invention matrix switching system including one or more of the switch frames coupled together thereby providing a scalable matrix switch having a variable number of input ports and output ports. The plurality of switch frames being controllable via a first or master switch frame as a unitary matrix switch.

In a preferred embodiment of the invention, the input and output ports of the individual switch frames are vertically and/or horizontally cascaded together via twisted pair patch cables which form a virtual backplane for the scalable system.

One advantage of the present invention system is that the switch frames provide modular building blocks wherein a plurality of the switch frames are configurable in scalable matrices to provide matrix switches of input by output sizes from 16×16 to 256×256.

Another advantage of the present invention system is that the entire matrix switching system whether formed of one or eighty modular switch frames “appears” to a user or controller as a single switch and is operable as a unitary matrix switch.

A further advantage of the present invention matrix switching system is that the input ports and output ports are connectable via twisted pair cable which is easily configured and/or reconfigured forming an external and scalable virtual backplane for the system.

These and other features, aspects, and advantages of the present invention will become better understood with reference to the following description, drawings and appended claims.

### BRIEF DESCRIPTION OF THE DRAWINGS

FIG. 1 is a front view of one embodiment of a modular switch frame according to the present invention.

FIG. 2 is a rear view of the switch frame of FIG. 1 including enlarged views of a serial interface and address control thereof.

FIG. 3 is a schematic view of the fully populated switch frame of FIG. 2 providing a matrix switch having 64 input ports and 16 output ports, (64×16 matrix switch).

FIG. 4 is a schematic view of two of the switch frames of FIG. 2 cascaded vertically to provide a matrix switch having 64 input ports and 32 output ports, (64×32 matrix switch).

FIG. 5 is a schematic view of two of the switch frames of FIG. 2 cascaded horizontally to provide a matrix switch having 112 input ports and 16 output ports, (112×16 matrix switch).

FIG. 6 is a schematic view of eight of the switch frames of FIG. 2 cascaded both vertically and horizontally to provide a matrix switch having 112 input ports and 64 output ports, (112×64 matrix switch).

FIG. 7 is a schematic view of sixteen of the switch frames of FIG. 2 cascaded both vertically and horizontally to provide a matrix switch having 208 input ports and 64 output ports, (208×64 matrix switch).

FIG. 8 is an illustration showing the rear side of two of the switch frames of FIG. 2 shown cascaded vertically in a 64×32 matrix switch including UTP cables coupling the switch frames one to the other and to compatible signal transmission devices.

FIG. 9 is an illustration showing the rear side of four of the switch frames of FIG. 2 shown cascaded both vertically and horizontally in a 112×32 matrix switch including UTP cables coupling the frames one to the other and to compatible signal transmission devices.

FIG. 10 is a table showing a preferred embodiment of the address assignments and input and output ports for each of eighty modular switch frames in a 256×256 matrix switch in accordance with the present invention.

FIG. 11 is a schematic view of the matrix switch of FIG. 6 including preferred address assignments for each of the switch frames thereof.

FIG. 12 is a schematic diagram showing the components of the switch frame of FIG. 2.

FIG. 13 is a circuit diagram showing one of the sixteen input and cascade output ports of a preferred embodiment of the present invention.

FIG. 14 is a circuit diagram showing one embodiment of each of the input ports of a switch frame of the present invention.

### DETAILED DESCRIPTION OF THE PREFERRED EMBODIMENT

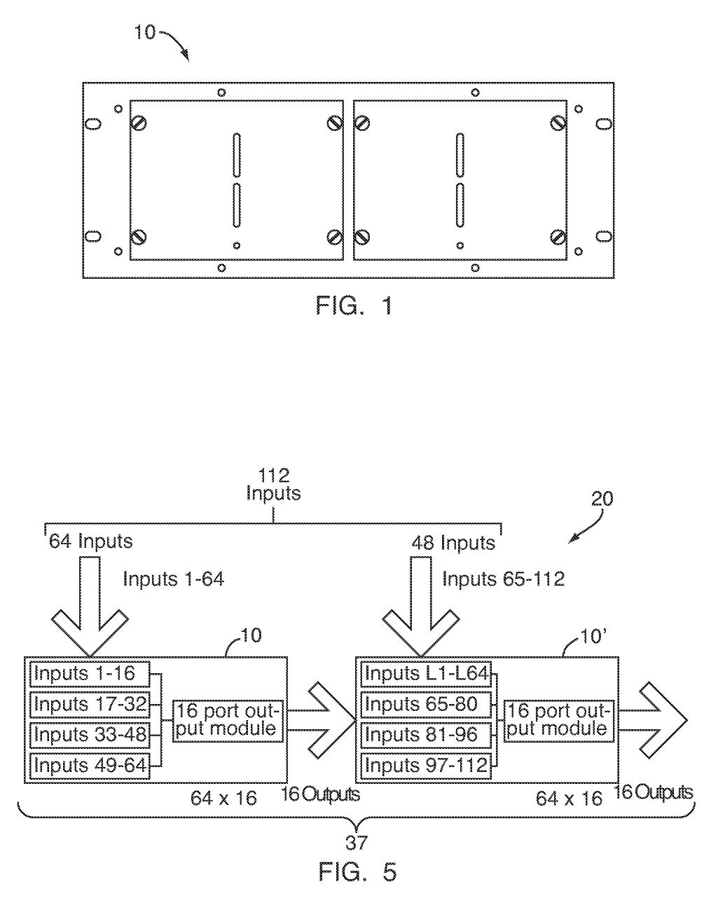

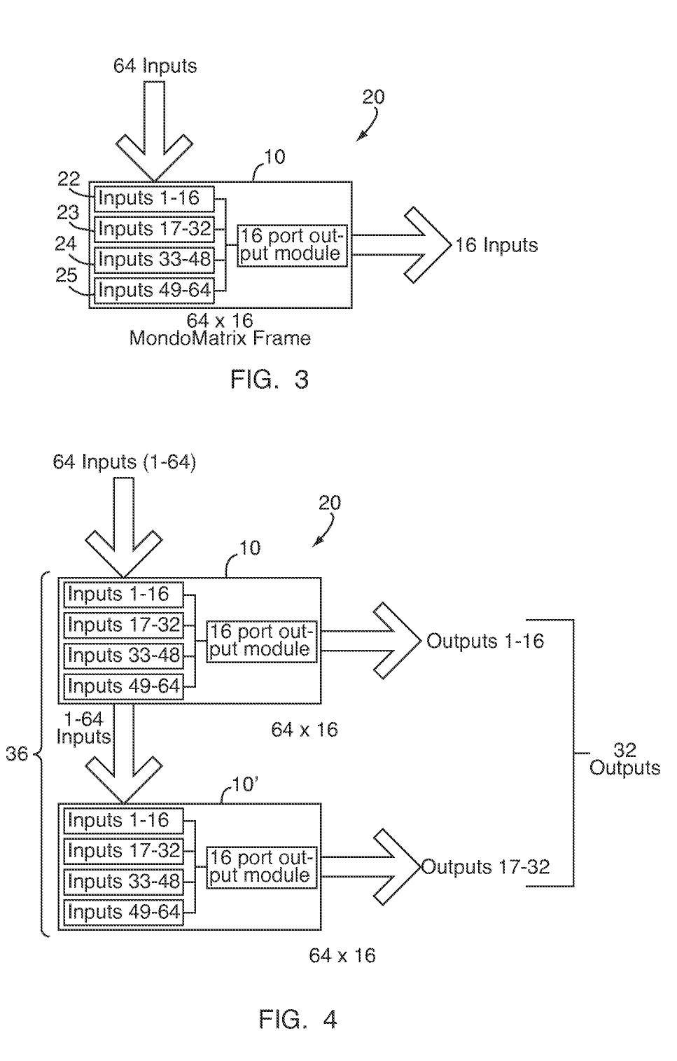

Referring to FIGS. 1-3, a switch frame generally referred to by the reference numeral 10 provides a modular building block for the present invention expandable matrix switching system 20. A matrix switching system 20, shown schematically in FIG. 3, includes one switch frame 10 which provides a maximum of 64 input ports and 16 output ports when fully populated. Multiple switch frames 10 cascaded both vertically and horizontally in various configurations provide non-blocking crosspoint matrix switching systems 20 having varying numbers of input and output ports as shown in FIGS. 4-7. The matrix switching system 20 can be configured as necessary depending on the application, to provide input/output matrix switches sized from 16×16 to 256×256.

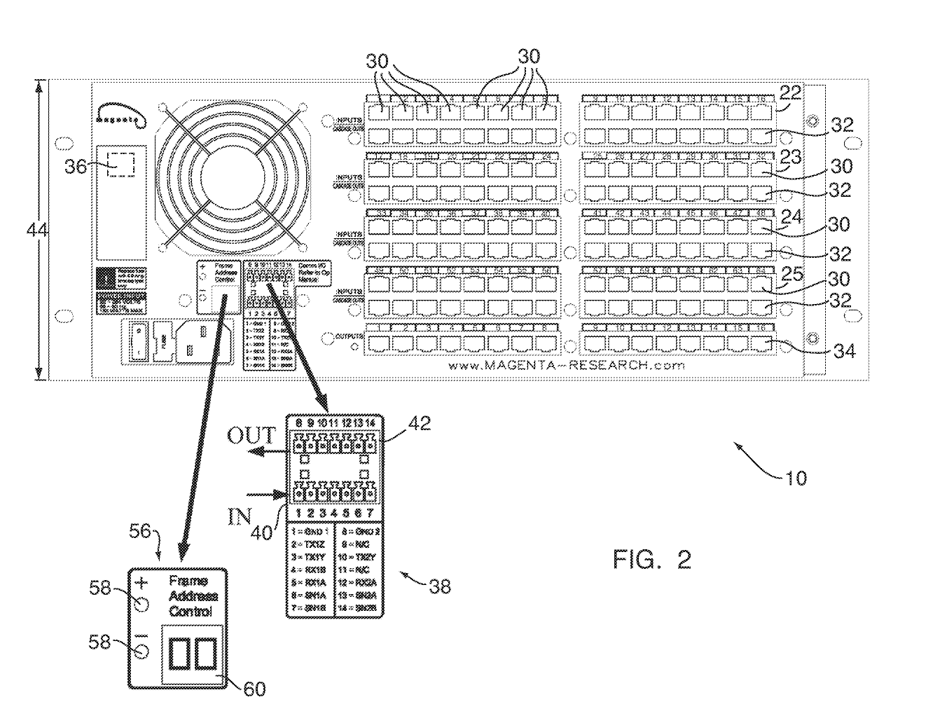

In a preferred embodiment as shown in FIGS. 1-2, the switch frame 10 has an overall height of 4 rack units (4 U). Thus, a 64×32 matrix switch according to the present invention occupies only 8 U of rack space (See FIG. 8). It is recommended, however, to leave 1 or 2 rack units of space between each of the modular switch frames 10 when mounted on a rack or racks and coupled together to form a matrix switching system 20 in accordance with the present invention.

Referring again to FIG. 2, the switch frame 10 includes up to four input modules (1-4), referred to by the reference numerals 22, 23, 24 and 25, respectively. Each of the input modules 22-25 are identical including sixteen input ports 30 and sixteen cascade output ports 32. In the illustrated embodiment, the switch frame 10 is fully populated with the maximum four input modules 22-25 installed in the switch frame. Alternatively, the switch frame 10 can be configured with less than four of the input modules 22-25 installed including any of one, two or three input modules. However, in most applications of the matrix switching system 20 having multiple switch frames 10, the switch frames are fully populated with four input modules each to maximize the number of input ports 30 which are connectable to the output ports 34.

The input module 22-25 installed in the switch frame 10 provide sixty-four input ports as follows: Input module 1—input ports nos. 1-16; Input module 2—input ports nos. 17-32; Input module 3—input ports nos. 33-48; and Input module 4—input ports nos. 49-64. Preferably, as shown in FIG. 2, the input ports 30 include female RJ-45 couplers for receiving a Cat5 twisted pair cable terminated with a corresponding male RJ-45 coupler.

Each switch frame 10 also includes sixteen output ports 34 which are selectively connectable to each of the input ports 30 (input ports nos. 1-64) in accordance with commands from a computer or other controller (not shown). Preferably, the output ports 34 each include a female RJ-45 coupler for receiving a Cat5 twisted pair cable terminated with a corresponding male RJ-45 coupler.

The switch frame 10 includes a processor 36 for receiving commands from a controller and controlling the switch paths in accordance with the input commands. In a preferred embodiment, the switch frame 10 is controlled by commands based on the Knox Video™ SAS (Simple ASCII Strings) RS-232 instruction set protocol which is known to one skilled in the art and will not be discussed further herein. Thus, the switch frame 10 provides a crosspoint matrix switch for routing input signals transmitted through the input ports 30 to various destination devices coupled to the output ports 34.

Still referring to FIG. 2, the input modules 22-25 each include sixteen cascade output ports 32. Each of the cascade output ports 32 are coupled to a corresponding one of the input ports 30. For example, the cascade output port number 15 is coupled to the input port number 15. In the switch frame 10, the cascade output ports 32 are conveniently located directly below the corresponding input ports 30 and share the same port identification number. The cascade output ports 32 are provided for transmitting the input signals from the switch frame 10 to another switch frame 10 cascaded vertically thereto as shown in FIGS. 4, 6-9 and 11. In a preferred embodiment, input signals delivered to the input ports 30 are buffered and without alteration sent to the corresponding cascade output port 32. As shown in FIG. 2, the cascade output ports 32 include female RJ-45couplers for receiving a Cat5 twisted pair cable terminated with a corresponding male RJ-45 coupler.

Still referring to FIG. 2, the switch frame 10 includes a serial interface 38 coupled to the processor 36. The serial interface 38 includes input and output terminals 40 and 42, respectively. As shown in the FIG. 2 embodiment, the input and output terminals 40, 42 are seven pin serial terminals. The input terminal 40 is used to connect the switch frame 10 to a controller or to the output terminal 42 of another switch frame 10 as will be discussed further hereinafter. The output terminal 42 is used in a matrix switching system 20 having multiple switch frames 10 wherein the output terminal of each switch frame 10 is coupled to the input terminal 40 of a next switch frame 10 in a daisy chain arrangement. Typically, a serial communications cable is used to couple the switch frame(s) 10 to a controller or to one another via the serial interface 38.

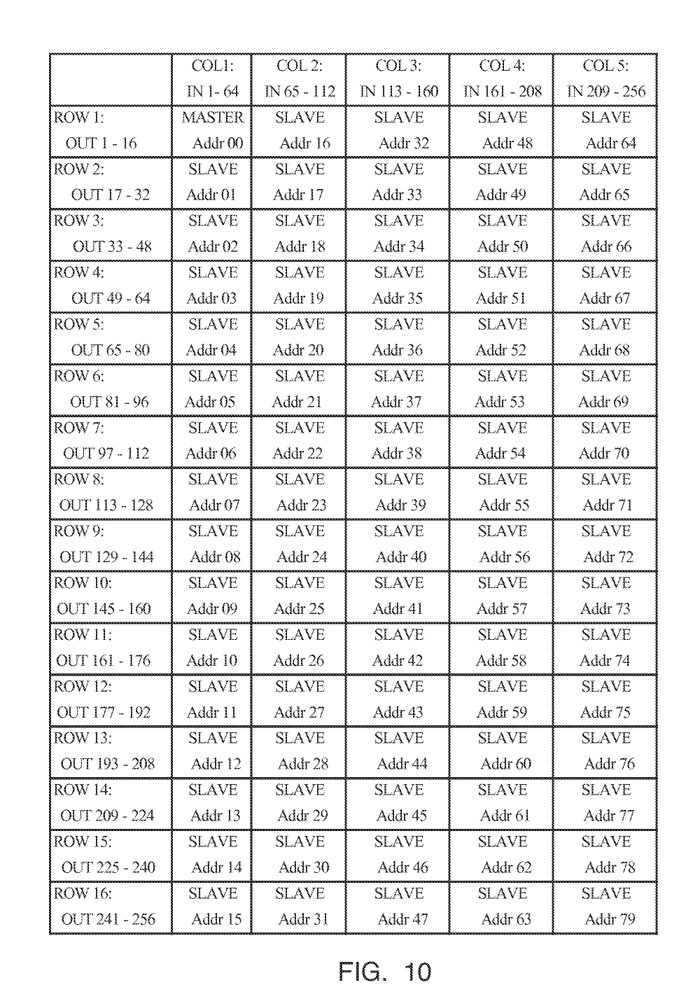

Referring to FIGS. 4 and 8, in a matrix switching system 20 the input signals forwarded to a first switch frame 10 through input ports numbers 1-64 are transferred to a second switch frame 10′ in a vertical cascade 36 by coupling the output cascade ports 32 of the first switch frame 10 to the corresponding input ports 30 of the second switch frame 10′ via Cat5 UTP (Unshielded Twisted Pair) cables 39 (See FIG. 8). Thus, the matrix switching system 20 of FIGS. 4 and 8 provides a 64×32 matrix switch which includes the two switch frames 10, 10′ coupled together in a vertical cascade 36. Vertically cascading the switch frames 10 and 10′ together increases the number of output ports 34 which are connectable to the input ports 30. In this case, with two switch frames 10, 10′ configured in a vertical cascade 36, the number of output ports is thirty-two. As shown in the table of FIG. 10, the present invention matrix switching system 20 provides for a maximum of sixteen switch frames 10 vertically cascaded one to the other providing up to two hundred fifty-six available output ports 34.

Still referring to FIG. 8, the first switch frame 10 of the matrix switching system 20 is designated a master switch frame and receives control commands from a controller via a communications cable 50 attached between a computer or other controller (not shown) and the input terminal 40 of the serial interface 38 of the switch frame 10. A communications cable 52 is coupled between the output terminal 42 of the serial interface 38 of the master switch frame 10 and the input terminal 40 of the serial interface 38 of the switch frame 10′ which is configured as a slave to the master switch frame 10. Thus, control signals delivered from the controller are received first by the master switch frame 10, processed as necessary, and forwarded to the appropriate slave switch frame 10′ via the master switch frame.

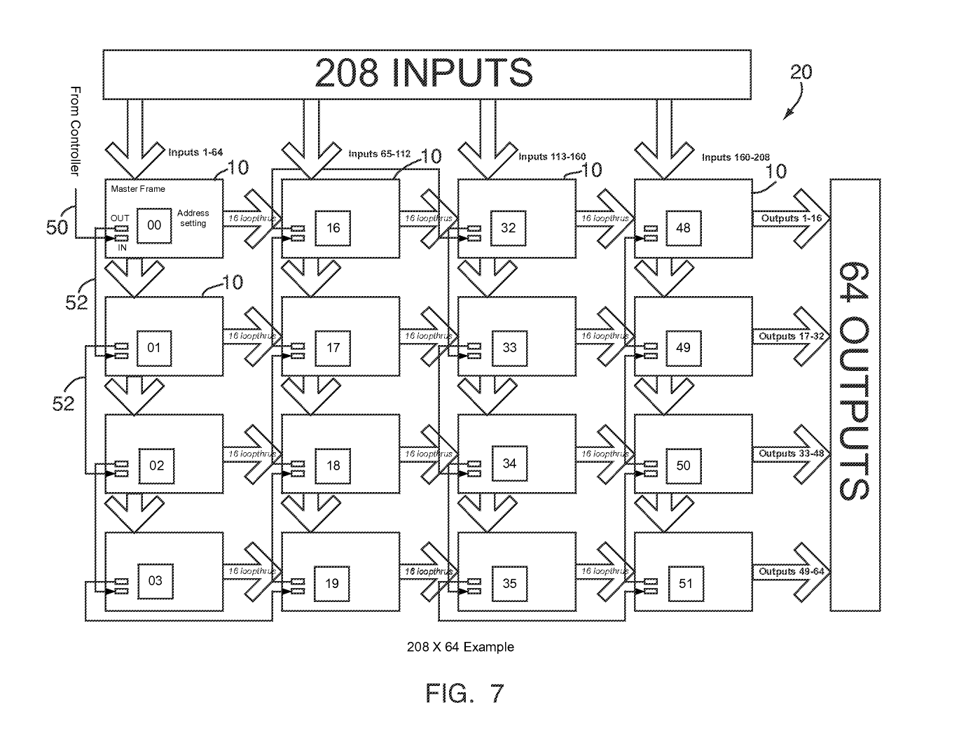

As shown in FIG. 7, the matrix switching system 20 includes the serial interface 38 of each switch frame 10 coupled via a communications cable 52 to a previous switch frame 10 in a daisy chain thereof. Typically, control commands are sent to the processor 36 of the master switch frame 10 as EIA-232 or 422 signals. The processor 36 generates sub-commands as necessary for carrying out the received command by the appropriate slave switch frames 10′ coupled to the master switch frame 10. The sub-commands generated by the master switch frame 10 are propagated through the all of the slave switch frames 10′ coupled in a daisy chain to the master switch frame 10. Each sub-command is processed by the designated slave switch frame 10′ to complete the signal path corresponding to the control command.

Referring now to FIG. 5, the switch frames 10 and 10′ can be configured in a horizontal cascade 37 for increasing the number of input ports 30 of the matrix switching system 20. As configured in FIG. 5, the horizontal cascade 37 includes the sixteen output ports 34 of the switch frame 10 coupled via external Cat5 UTP cables (not shown) to sixteen of the input ports 30 of the switch frame 10′ thereby providing for the connection of all of the input ports nos. 1-64 of the switch frame 10 and the input ports nos. 65-112 of the switch frame 10′ to the output ports nos. 1-16 of the switch frame 10′. Thus, as configured in FIG. 5, the horizontally cascaded switch frames 10 and 10′ provide a 112×16 matrix switch. Configured in the horizontal cascade 37 of FIG. 5, the switch frame 10′ is a slave to the master switch frame 10 and receives control commands through the master switch frame 10. Although, not shown in FIG. 5, a communications cable 50 is coupled between a controller and the serial input port 40 of the master switch frame 10 and a second communications cable 52 is coupled between the serial output port 42 of the master switch frame 10 and the serial input port 40 of the slave switch frame 10′. As set forth above, control commands from the controller are delivered first to the master switch frame 10 and processed thereby including generating sub-commands as necessary for a particular switch path, which are then forwarded to the appropriate slave switch frames 10′ through a daisy chain thereof. Thus, regardless of how many slave switch frames 10′ are included in the matrix switching system 20, the control commands are delivered to a single master switch frame 10 such that all of the multiple switch frames act as a unitary switch regardless of the number thereof.

Referring to FIGS. 4-11, depending on the requirements of a particular application, the matrix switching system 20 of the present invention is configurable using multiple switch frames 10 cascaded horizontally, vertically, or both as described above, to provide matrix switches in various sizes (input×output) from 16×16 to 256×256.

Referring again to FIG. 2, each switch frame 10 includes a configurable address module 56 including input controls 58 and an address display 60. The address module 56 is configurable via the input controls 58 to increment/decrement the address module and assign a unique address to each switch frame 10 in a matrix switching system 20. For controlling the individual switch frames 10 in the matrix switching system 20, each switch frame must be assigned a unique address. The address assigned to the switch frame 10 is displayed on the address display 60 such that the address assignment for each switch frame can be easily confirmed visually via the address display.

Referring to FIG. 10, in a preferred embodiment of the matrix switching system 20, each switch frame 10 is assigned a predetermined address depending on the position of the switch frame in the matrix switching system. The master switch frame is assigned the address 00. There can be only one master switch frame in a matrix switching system 20. Each switch frame 10′ coupled as a slave to the master switch frame 10 is assigned a next incremental address in a column by column fashion wherein each column always begins with switch frames assigned with the following addresses: Address: 00; Address: 16; Address 32; Address 48; and Address 64, respectively. Thus, a matrix switching system 20 providing a 256×256 matrix switch includes eighty switch frames having assigned addresses numbered 00-79 coupled together in a vertically and horizontally cascaded matrix having five columns and sixteen rows of switch frames 10.

As shown in FIG. 10, the present invention matrix switching system 20 can have a maximum of sixteen vertically cascaded switch frames 10 to provide two hundred fifty-six output ports 34. A maximum of five columns of switch frames may be used providing up to two hundred fifty-six input ports 30. In a preferred embodiment, column 1 contains switch frames 10 having the addresses 00-15; column 2 contains switch frames having the addresses 16-31; column 3 contains switch frames having the addresses 32-47; column 4 contains switch frames having the addresses 48-63; and column 5 contains switch frames having the addresses 64-79.

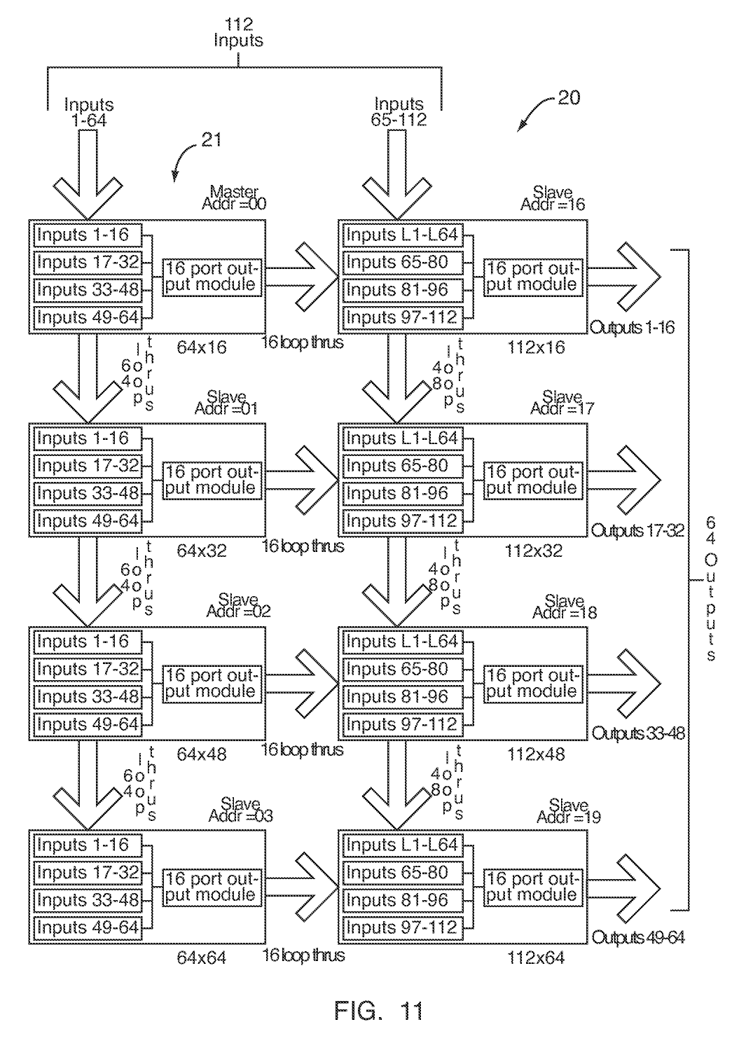

FIG. 11 shows a matrix switching system 20 providing a 112×64 matrix switch formed by coupling 8 switch frames 10 in a matrix having 2 columns of 4 rows each. As shown in FIG. 11, in a preferred embodiment, the first switch frame in the first and second columns are assigned the addresses 00 and 16 respectively with each of the next switch frames in the columns having an address incrementally increased by one over the previous switch frame in the same column. Thus, in the FIG. 11 embodiment, the first column 21 has switch frames 10 with assigned addresses 00, 01, 02, and 03 and the second column 23 has switch frames with assigned addresses of 16, 17, 18, and 19. The predetermined assigned addresses in the preferred embodiment of the matrix switching system 20 provide for uniformity in programming the processor 36 to complete the switching commands necessary for the routing an input signal through multiple switch frames 10 to the appropriate output port 34.

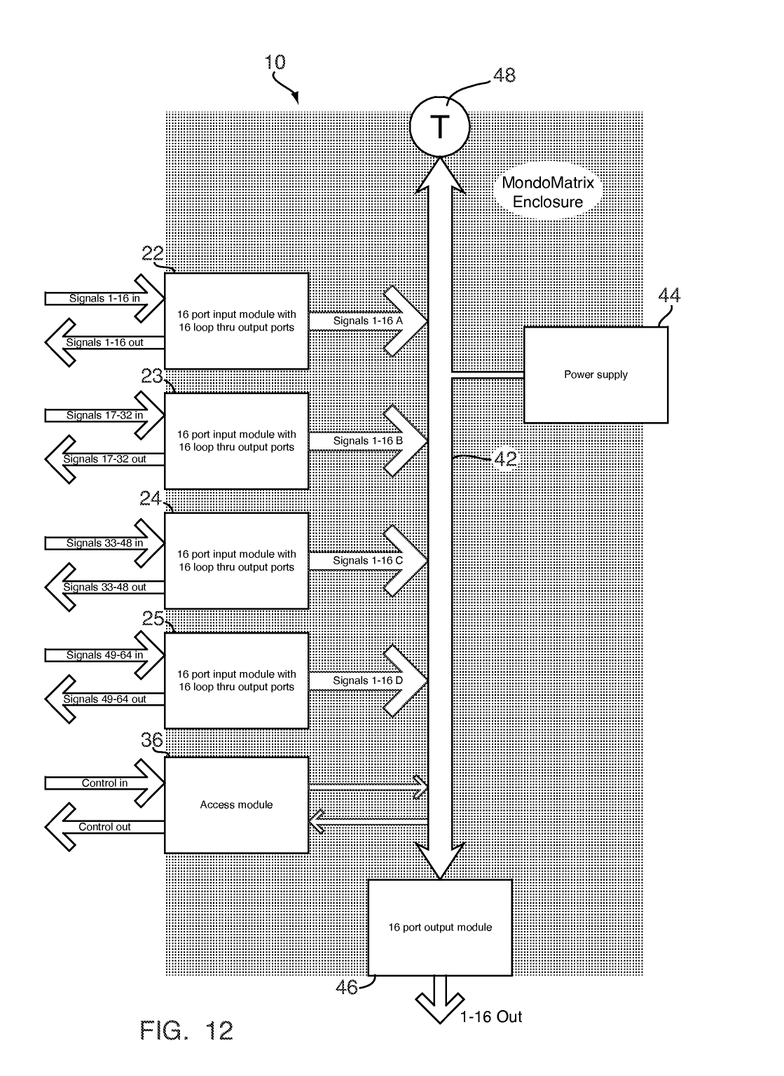

Referring to FIG. 12, the switch frame 10 includes a signal bus 42 that is coupled to and powered by a power supply 44. The input modules 22-25 and an output module 46 are coupled to the signal bus 42. The output module 46 includes the 16 output ports 34. A terminator 48 is attached at the end of the signal bus 42 for absorbing signals and to prevent reflection of signals back down the bus. The processor 36 is coupled to the signal bus 42 and controls the routing of signals between the input ports 30 and output ports 34 in accordance with commands from a controller.

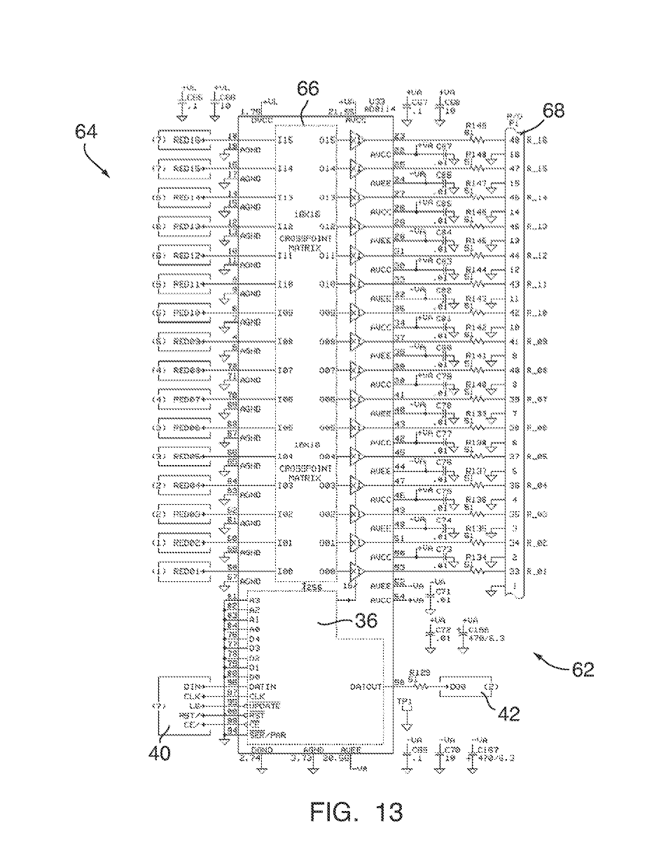

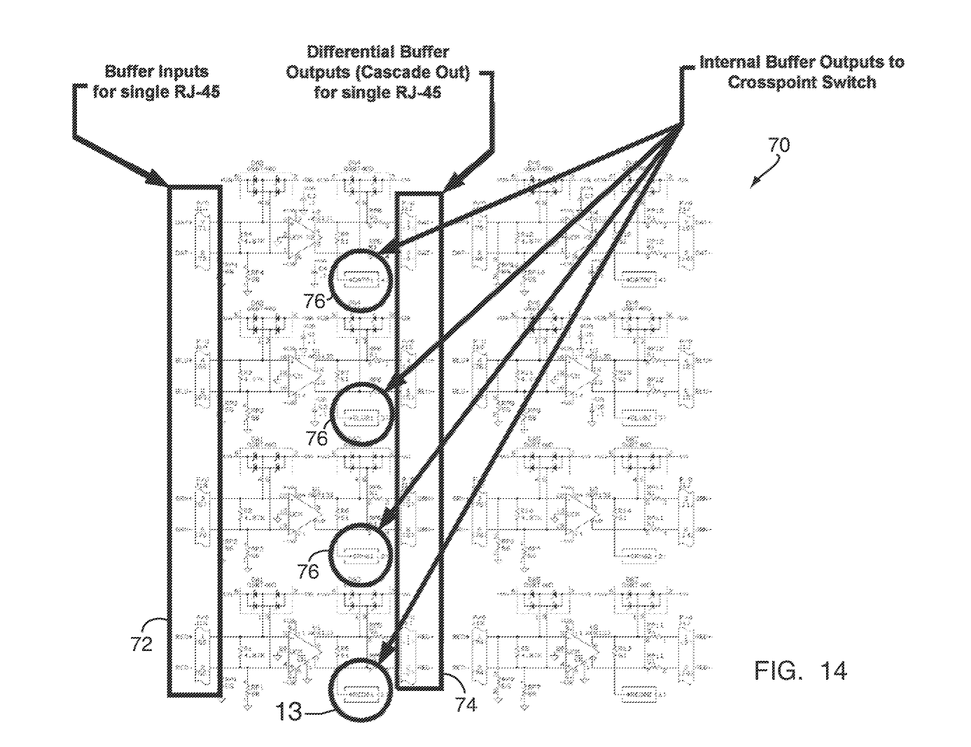

FIG. 13 is circuit diagram 62 of a preferred embodiment of switch frame 10 including sixteen input ports, generally 64 coupled to a crosspoint matrix switch 66 and output ports, generally 68. A processor 36 is shown coupled to serial input and output ports 40 and 42, respectively and the crosspoint matrix switch 66.

Referring to FIG. 14, a circuit diagram of one embodiment of each of the RJ-45 input ports 30 of a switch frame 10 is shown generally at 70. As set forth above, the input signal at each input port 30 is accurately buffered and without alteration sent to a corresponding cascade output port 32. The buffering process includes broad bandwith differential input and differential output operational amplifiers. There are four amplifiers, generally referred to by the reference number 72, per input/output port, one for each pair of the UTP. The input ports 30 are forwarded terminated in accordance with the cable characteristic impedance for UTP of 100 Ohms. Matching the termination impedance to the cable's characteristic impedance is necessary to reduce reflections and provide the desired flat passband. All of the output ports 32, 34 are reverse terminated at 100 Ohms for the same reason. Each of the four differential buffers for each cascade output port 32 are shown generally at 74. The four internal outputs to the crosspoint switch 66 from a single RJ-45 input port 30 are also reverse terminated at 100 Ohms as shown generally at 76.

The forward and reverse termination at the inputs and outputs as set forth above results in a 6 dB reduction of gain across the entire passband each time a signal is propagated through and recovered from a UTP cable. This 6 dB loss is overcome by a 6 dB gain over the internal buffer. Thus, the signal at the cascade output ports 32 is a very accurate duplicate of the input signal and can be ported from one switch frame 10 to the corresponding input port 30 of a next switch frame 10 and so on, to each of a plurality of vertically cascaded switch frames 10 in a matrix switching system 20.

Similarly, in a horizontal cascade 37 (See FIG. 5), the output ports 34 of a switch frame 10 (normally all sixteen) are cascaded into the same number of input ports 30 of a next switch frame 10′. The signals are buffered as set forth above so that as many switch frames 10 as necessary (up to the maximum size of 256 inputs) are horizontally cascaded without affecting the quality of the output signals therefrom.

In use of a matrix system 20, an individual control command associates an input port 30 with one or more output ports 34 of the system. To effect the closure of crosspoints, the matrix switching system 20 is controlled exclusively by an interfaced signal sent to the processor 36 via the serial input 40 of a master switch frame 10 of the matrix switching system. Even though the matrix switching system 20 may include one or more switch frames 10, the system always “appears” to the user or controlling subsystem as one coherent or continuous matrix switch. Thus, to effect a switching operation, a user need only to specify one input port 30 and a single output port 34 or multiple output ports 34.

In matrix routing systems, each individual control command associates an input with one or more output(s). This is typically accomplished by sending an output assignment, an input assignment and then a take or salvo command. In the present invention matrix switching system 20, multiple switch frames 10 are cascaded horizontally to increase the number of input ports 30, and vertically to increase the number of output ports 34 depending on the application. Thus, input signals need to be routed through multiple frames to the appropriate output port 34.

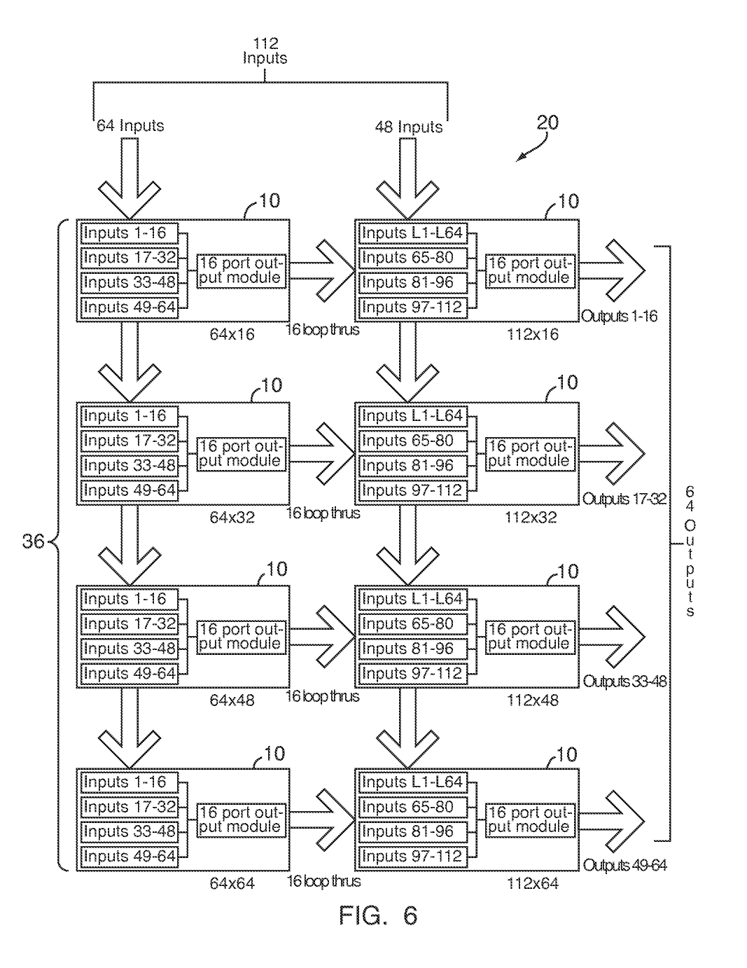

As an example, in a 112×64 matrix switching system 20 (See FIG. 6) when input port no. 1 needs to be routed to output port no. 1, two individual switch frames 10 must be operated, namely, the switch frame at address 00 and the switch frame at address 16. First, the input no. 1 must be routed to output no. 1 of the switch frame at address 16. Then the input no. 1 of the switch frame at address 16 must be routed to output no. 1 thereof.

In a second example, if input no. 63 is to be routed to output no. 12, the following switching commands must be completed. Input no. 63 of the switch frame at address 00 is routed to output no. 12 thereof; and input no. 12 of the switch frame 10 at address 16 is routed to output no. 12 of the switch frame at address 16. To clarify, if a user specifies a route that needs to pass through multiple switch frames 10, then multiple separate commands (sub-commands, one for each involved switch frame) need to be generated by the processor of the master switch frame.

Thus, each control command, regardless of how many switch frames are involved, is sent to the master switch frame wherein the appropriate sub-commands are generated and forwarded to the appropriate slave switch frame 10′ through a daisy chain of slave switch frames coupled to the master switch frame 10. As set forth above, this is accomplished by assigning one frame as a master switch frame 10 with all others assigned as slave switch frames 10′ coupled serially to the master switch frame. Accordingly, the master switch frame 10 accepts simple routing commands from a controller and processes them and thereafter provides routing sub commands to the slave switch frames 10′.

Control commands are sent to the master switch frame 10 as EIA-232 or 422 signals. After being processed by the master switch frame's processor 36 (CPU), the sub commands are propagated through all of the processors 36 of the slave switch frames 10′ as shown in FIG. 7. Thus, regardless of the number of switch frames 10 in the matrix switching system 20, only one control port is coupled to the controller via the communications cable 50.

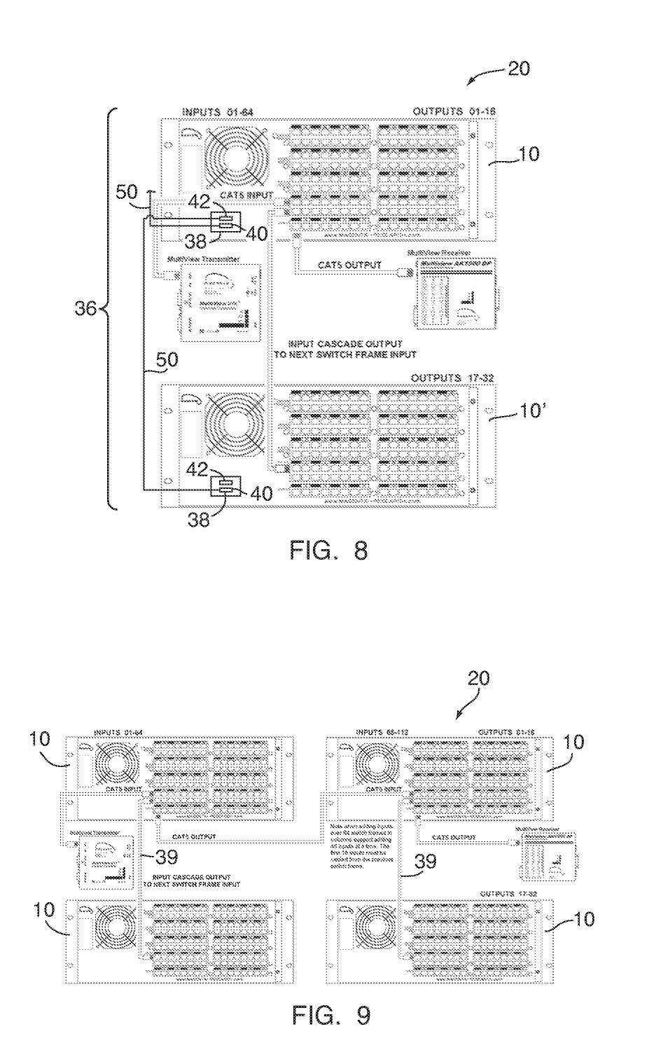

By employing the building block approach of the present invention, the signal-carrying layer of the matrix system 20 is distributed via UTP patch cables 39 (See FIGS. 8 and 9). The external UTP patch cables 39 connected between the modular switch frames 10 form an external or “virtual” backplane which is easily scalable depending on the application.

The compactness of the RJ-45 couplers utilized in the present invention matrix switching system 20 contributes dramatically to the reduced size of the overall physical size of the system when compared with prior art systems using BNC type couplers. Additionally, the diminutive size of the couplers allows the internal configuration of the switch frame 10 to be arranged so that all of the related signals are transmitted in close proximity to each other on various PCB substrates. This reduces the probability of propagation time variation and inconsistent passband behavior for the related signals, both of which are significant concerns in the transmission of high resolution video signals.

The foregoing description of embodiments of the invention has been presented for the purpose of illustration and description, it is not intended to be exhaustive or to limit the invention to the form disclosed. Obvious modifications and variations are possible in light of the above disclosure. The embodiments described were chosen to best illustrate the principals of the invention and practical applications thereof to enable one of ordinary skill in the art to utilize the invention in various embodiments and with various modifications as suited to the particular use contemplated. It is intended that the scope of the invention be defined by the claims appended hereto.

What is claimed is:

1. A switch frame for use in an expandable matrix switching system for routing video and other signals from a variable number of inputs to a variable number of outputs, the switch frame comprising:
a plurality of input ports for receiving input signals from an input device;
a plurality of output ports connectable to one or more destination devices;
a crosspoint switch connected between said input ports and said output ports for routing signals from said input ports to said output ports;
a processor coupled to and controlling said crosspoint switch for connecting a selected one of said input ports to one or more of said output ports in accordance with commands from a controller;
a communications port for coupling said processor to a controller or another switch frame;
a plurality of cascade output ports coupled to said input ports for cascading input signals to the corresponding input ports of another switch frame.

2. The switch frame of claim 1 further comprising a configurable address module for assigning an address to said switch frame.

3. The switch frame of claim 1 wherein said communications port includes both an input communications port and an output communications port.

4. The switch frame of claim 1 having a removable input module connectable to said crosspoint switch wherein said input ports and said cascade output ports are contained in said input module, said switch frame including a housing for receiving a plurality of said input modules.

5. The switch frame of claim 1 wherein said input and output ports include RJ-45 couplers for use in routing signals transmitted over twisted pair cables.

6. The switch frame of claim 1 further comprising means for buffering said input signals for providing accurate duplications thereof at said output ports and said cascade output ports.

7. An expandable matrix switching system for routing video and other signals from a variable number of inputs to a variable number of outputs, the system comprising:
first and second switch frames each having a plurality of input ports for receiving input signals from an input device, a plurality of output ports connectable to one or more destination devices, a crosspoint switch connected between said input ports and said output ports for routing signals from said input ports to said output ports, a processor coupled to and controlling said crosspoint switch for connecting a selected one of said input ports to one or more of said output ports in accordance with commands from a controller, input and output communications ports for coupling said processor to a controller or another switch frame, and a plurality of cascade output ports coupled to said input ports for cascading input signals to the corresponding input ports of another switch frame;
at least one of said cascade output ports of said first switch frame coupled to a corresponding one of said input ports of said second switch frame;
said input communications port of said first switch frame connectable to a controller for receiving control commands for said system;
said output communications port of said first switch frame coupled to said input communications port of said second switch frame for transmitting control commands from said first switch frame to said second switch frame; and wherein
said first and second switch frames are vertically cascaded one to the other for increasing the number of available output ports connectable to the input ports of said first switch frame.

8. The matrix switching system of claim 7 wherein said first and second switch frames each have a configurable address module for assigning a unique address to each of said switch frames.

9. The matrix switching system of claim 8 wherein said first and second switch frames are assigned predetermined addresses in accordance with a position of each said switch frame in said system.

10. The matrix switching system of claim 7 wherein at least a portion of said input ports of said second switch frame are coupled to a corresponding portion of said cascade output ports of said first switch frame via UTP cables.

11. The matrix switching system of claim 7 wherein said second switch frame is controlled via control commands received from said processor of said first switch frame.

12. The matrix switching system of claim 7 wherein said processor of said first switch frame generates control commands for said second switch frame upon receipt of a switching command from a controller.

13. The matrix switching system of claim 7 further comprising third and fourth switch frames wherein,
a portion of the output ports of said first switch frame are coupled to a portion of the input ports of said third switch frame horizontally cascading said third switch frame to said first switch frame;
a portion of the output ports of said second switch frame are coupled to a portion of the input ports of said fourth switch frame horizontally cascading said fourth switch frame to said second switch frame;
a portion of said cascade output ports of said third switch frame are coupled to a corresponding portion of said input ports of said fourth switch frame vertically cascading said fourth switch frame to said third switch frame;
said input and output communication ports of said second, third, and fourth switch frames are serially connected to said first switch frame in a daisy chain arrangement;
each said switch frame includes a configurable address module having a unique address assigned thereto; and
wherein said first, second, third and fourth switch frames collectively provide a matrix switch controllable via said first switch frame for routing input signals from said selected input ports of said first and third switch frames to designated output ports of said third and fourth switch frames in response to commands from a controller coupled to said processor of said first switch frame.

14. The matrix switching system of claim 13 further comprising a plurality of switch frames vertically and/or horizontally cascaded one to the other.

15. The matrix switching system of claim 13 including UTP cables coupling said input, output and cascade output ports of said switch frames together.

16. An expandable matrix switching system for routing video and other signals from a variable number of inputs to a variable number of outputs, the system comprising:
first and second switch frames each having a plurality of input ports for receiving input signals from an input device, a plurality of output ports connectable to one or more destination devices, a crosspoint switch connected between said input ports and said output ports for routing signals from said input ports to said output ports, a processor coupled to and controlling said crosspoint switch for connecting a selected one of said input ports to one or more of said output ports in accordance with commands from a controller, input and output communications ports for coupling said processor to a controller or another switch frame, and a plurality of cascade output ports coupled to said input ports for cascading input signals to the corresponding input ports of another switch frame;
at least one of said output ports of said first switch frame coupled to one of said input ports of said second switch frame;
said input communications port of said first switch frame connectable to a controller for receiving control commands for said system;
said output communications port of said first switch frame coupled to said input communications port of said second switch frame for transmitting control commands from said first switch frame to said second switch frame; and
wherein said first and second switch frames are horizontally cascaded one to the other for increasing the number of available inputs ports of said system.

17. The matrix switching system of claim 16 wherein said first and second switch frames each have a configurable address module for assigning a unique address to each of said switch frames.

18. The matrix switching system of claim 17 wherein said first and second switch frames are assigned predetermined addresses in accordance with a position of each said switch frame in said system.

19. The matrix switching system of claim 16 wherein a portion of said output ports of said first switch frame are coupled to a portion of said input ports of said first switch frame via UTP cables.

20. The matrix switching system of claim 16 wherein said second switch frame is controlled via control commands received from said processor of said first switch frame.
